(19) United States
(12) Patent Application Publication
(10) Pub. No.: US 2025/0141137 A1
(43) Pub. Date: May 1, 2025

(54) EDGE CONNECTOR

(71) Applicant: JAPAN AVIATION ELECTRONICS INDUSTRY, LIMITED, Tokyo (JP)

(72) Inventor: Tetsuya KOMOTO, Tokyo (JP)

(73) Assignee: JAPAN AVIATION ELECTRONICS INDUSTRY, LIMITED, Tokyo (JP)

(21) Appl. No.: 18/882,778

(22) Filed: Sep. 12, 2024

(30) Foreign Application Priority Data
Oct. 31, 2023 (JP) 2023-187142

(51) Int. Cl. H01R 12/73; H01R 12/70

(52) U.S. Cl. CPC H01R 12/737; H01R 12/7064

(57) ABSTRACT

Each of contacts of an edge connector has a first mounted portion, a first held portion, a contact portion, a second held portion and a second mounted portion. The first mounted portion and the second mounted portion are fixed to a mount object when the edge connector is mounted on the mount object. The first held portion is located between the first mounted portion and the contact portion in the contact, and the second held portion is located between the second mounted portion and the contact portion in the contact. The first held portion and the second held portion are held by a housing. The contact portion is located between the first held portion and the second held portion in the contact and located in an accommodation portion of the housing.

### CROSS REFERENCE TO RELATED APPLICATIONS

This application is based on and claims priority under 35 U.S.C. § 119 to Japanese Patent Application No. JP2023-187142 filed Oct. 31, 2023, the contents of which are incorporated herein in their entirety by reference.

### BACKGROUND OF THE INVENTION

This invention relates to an edge connector.

JP2013-143387A (Patent Document 1) discloses an example of an edge connector.

Referring to FIG. 18, an edge connector 90 disclosed in Patent Document 1 has a housing (an insulating body) 92, a contact (a connector element) 94 held by the housing 92 and an attaching leg 96 fixed to the housing 92.

As shown in FIG. 18, the contact 94 is provided in a hollow portion 901 of the housing 92, and a head portion 941 of the contact 94 is located in an open socket 943 of the housing 92. The contact 94 is resiliently deformable at least in part, and the head portion 941 is movable at least in a lateral direction in FIG. 18.

As understood from FIG. 18, when a card edge (not shown) is inserted into the open slot 943, the contact 94 is pressed by the card edge and resiliently deformed. The head portion 941 is pressed onto a terminal contact point (not shown) provided on the card edge by a reaction force of the contact 94 and electrically connected to the terminal contact point.

### SUMMARY OF THE INVENTION

In the edge connector 90 of Patent Document 1, the contact 94 has relatively high rigidity. Accordingly, there is a demand for an edge connector provided with a contact having relatively lower rigidity. Although making the head portion 941 of the contact 94 long allows a reduction in the rigidity of the contact 94, it increases a height of the edge connector 90 and makes it impossible to meet a low-profile requirement of the edge connector 90. In addition, if a resilient limit of the contact 94 is reduced by reducing the rigidity of the contact 94, possibility of plastic deformation or buckling of the contact 94 becomes higher in an event of insertion or extraction of the card edge. Accordingly, there is a demand for an edge connector which meets a low-profile requirement thereto and whose contact has reduced rigidity without reducing resilient limit thereof. In other words, there is a demand for an edge connector whose contact has an improved spring property.

It is an object of the present invention to provide an edge connector provided with a contact whose spring property is improved.

One aspect of the present invention provides an edge connector which is mounted on a mount object and into which an edge portion of a connection object is inserted. The edge connector comprises a housing and a contact. The housing has an accommodation portion which accommodates the edge portion. The contact has a first mounted portion, a first held portion, a contact portion, a second held portion and a second mounted portion. The first mounted portion and the second mounted portion are fixed to the mount object when the edge connector is mounted on the mount object. The first held portion is located between the first mounted portion and the contact portion in the contact. The second held portion is located between the second mounted portion and the contact portion in the contact. The first held portion and the second held portion are held by the housing. The contact portion is located between the first held portion and the second held portion in the contact and located in the accommodation portion.

In the edge connector of the above-mentioned aspect, the contact has the first mounted portion, the first held portion, the contact portion, the second held portion and the second mounted portion. In the contact, the first held portion is located between the first mounted portion and the contact portion while the second held portion is located between the second mounted portion and the contact portion. Moreover, the contact portion is located between the first held portion and the second held portion in the contact and is located in the accommodation portion of the housing. With this structure, the edge connector can be provided with the contact which has an improved spring property.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a top, perspective view showing an edge connector according to an embodiment of this invention, a mount object and a connection object. The edge connector is mounted on a first surface of the mount object which is directed upward. The connection object is not inserted into the edge connector.

FIG. 2 is a bottom, perspective view showing the edge connector of FIG. 1, the mount object and the connection object.

FIG. 3 is a top view showing the edge connector of FIG. 1 and a part of the mount object.

FIG. 4 is a bottom view showing the edge connector of FIG. 1 and a part of the mount object.

FIG. 5 is a front view showing the edge connector of FIG. 1 and the mount object.

FIG. 6 is a side view showing the edge connector of FIG. 1 and the mount object.

FIG. 7 is a cross-sectional view showing the edge connector of FIG. 5 and the mount object, taken along line A-A.

FIG. 8 is an exploded, top, perspective view showing the edge connector of FIG. 1.

FIG. 9 is an exploded, bottom, perspective view showing the edge connector of FIG. 8.

FIG. 10 is a top, perspective view showing the edge connector of FIG. 8.

FIG. 11 is a bottom, perspective view showing the edge connector of FIG. 9.

FIG. 12 is another bottom, perspective view showing the edge connector of FIG. 1 and the mount object. The edge connector is mounted on the first surface of the mount object which is directed downward.

FIG. 13 is a cross-sectional view showing the edge connector of FIG. 12 and the mount object. The sectional position corresponds to line A-A in FIG. 5.

FIG. 14 is a top, perspective view showing a first modification of the edge connector of FIG. 1, the mount object and the connection object. The edge connector is mounted on the first surface of the mount object which is directed upward. The connection object is not inserted into the edge connector.

FIG. 15 is a cross-sectional view showing the edge connector of FIG. 14 and the mount object. The sectional position corresponds to line A-A in FIG. 5.

FIG. 16 is a top, perspective view showing a second modification of the edge connector of FIG. 1, the mount object and the connection object. The edge connector is mounted on the first surface of the mount object which is directed upward. The connection object is not inserted into the edge connector.

FIG. 17 is a cross-sectional view showing the edge connector of FIG. 16 and the mount object. The sectional position corresponds to line A-A in FIG. 5.

FIG. 18 is a cross-sectional view showing an edge connector disclosed in Patent Document 1.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

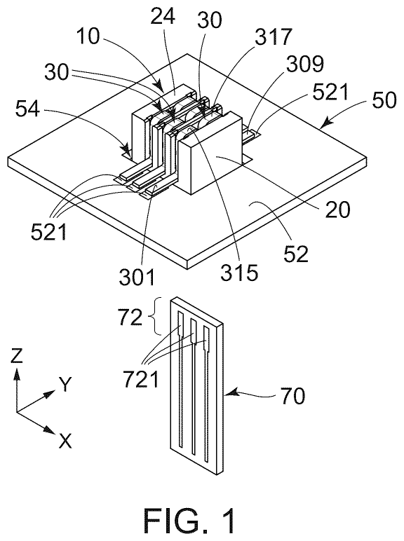

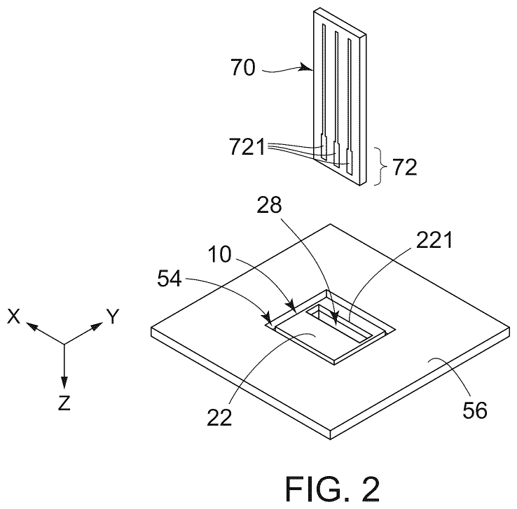

Referring to FIGS. 1 and 2, an edge connector 10 according to an embodiment of this invention is a connector which is mounted on a mount object 50 and into which an edge portion 72 of a connection object 70 is inserted. In the present embodiment, the mount object 50 is a substrate 50. Moreover, in the present embodiment, the connection object 70 is a module card 70.

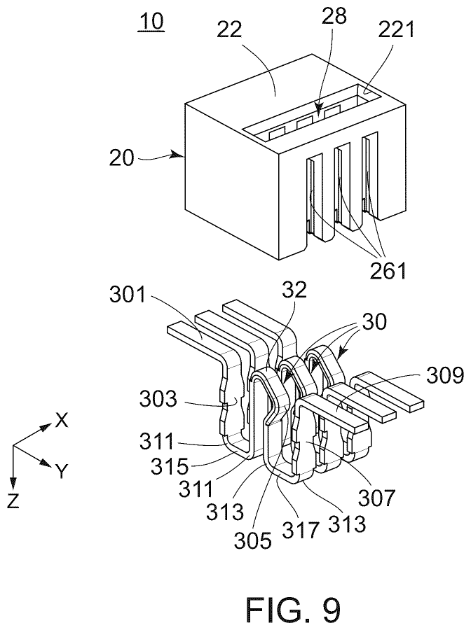

Referring to FIGS. 8 and 9, the edge connector 10 according to the present embodiment is provided with a housing 20 and a plurality of contacts 30. In the present embodiment, the contacts 30 are formed so that they are identical with each other in shape. Moreover, in the present embodiment, the contacts 30 are three in number. However, the present invention is not limited thereto. In the present invention, the edge connector 10 should be provided with at least one contact 30.

As understood from FIGS. 8 and 9, the housing 20 is made of insulation resin and has an outer shape of an approximately rectangular parallelepiped. Moreover, the housing 20 has a mating surface 22 in which an aperture 221 is formed and an opposite surface 24 opposite to the mating surface 22. In the present embodiment, the mating surface 22 is directed downward in an up-down direction while the opposite surface 24 is directed upward in the up-down direction. In the present embodiment, the up-down direction is a Z-direction. A positive Z direction is directed upward while a negative Z direction is directed downward.

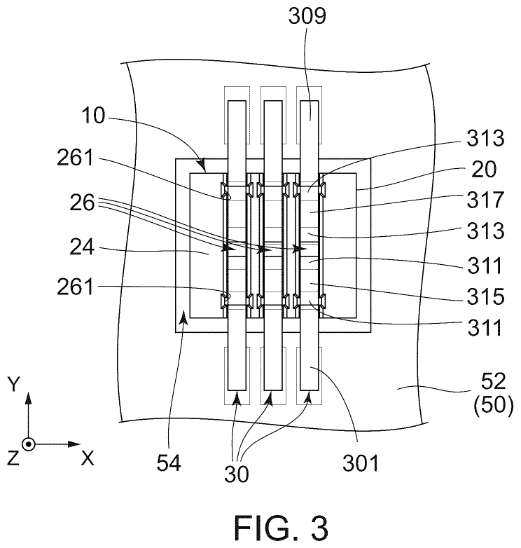

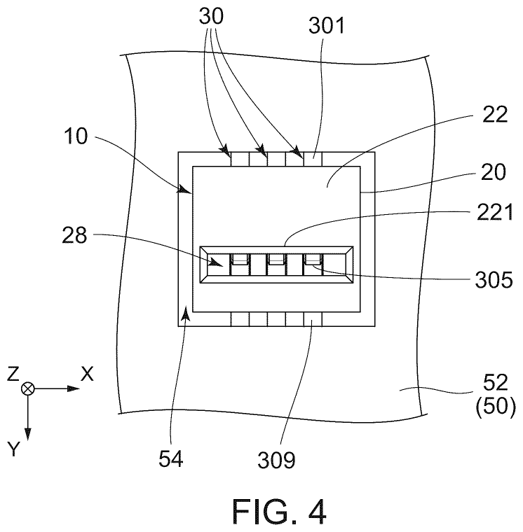

As shown in FIGS. 3 and 8, the housing 20 has receiving portions 26 corresponding to the contacts 30, respectively, each of which is partly received in the receiving portion 26 corresponding thereto. Moreover, as shown in FIGS. 4 and 9, the housing 20 has an accommodation portion 28 which accommodates the edge portion 72 (see FIG. 2) of the module card 70 (see FIG. 2). In the present embodiment, the receiving portions 26 open upward. Moreover, in the present embodiment, the accommodation portion 28 opens downward and communicates with the aperture 221. In other words, the aperture 221 of the housing 20 communicates with the accommodation portion 28. The edge portion 72 of the module card 70 is insertable into the accommodation portion 28 through the aperture 221.

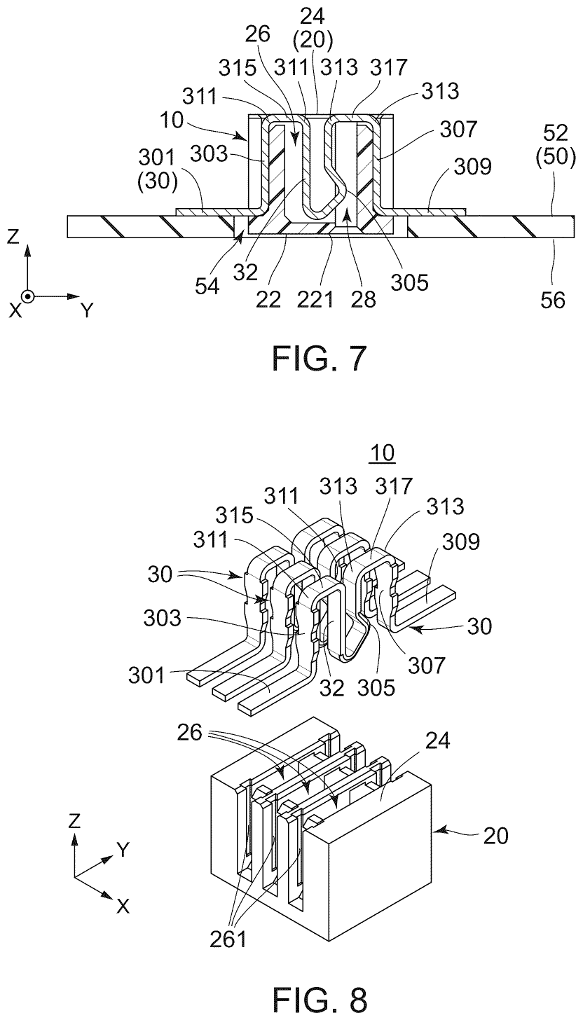

Referring to FIGS. 7 to 9, each of the contacts 30 is formed of a single metal member. The contact 30 has a first mounted portion 301, a first held portion 303, a supporting portion 32, a second held portion 307 and a second mounted portion 309 in this order from one of end portions thereof to the other of the end portions. Each of the first mounted portion 301 and the second mounted portion 309 extends in a front-rear direction. Each of the first held portion 303 and the second held portion 307 extends in the up-down direction. The supporting portion 32 has a U-shape part having an approximately U-shape and coupling parts which couple the U-shape part to the first held portion 303 and the second held portion 307, respectively.

As understood from FIGS. 7 to 9, the supporting portion 32 includes a contact portion 305, at least one first bent portion 311 and at least one second bent portion 313. In the present embodiment, the at least one first bent portion 311 is two in number, and the at least one second bent portion 313 is two in number. Moreover, in the present embodiment, the supporting portion 32 includes a first coupling portion 315 which couples the two first bent portions 311 to each other and a second coupling portion 317 which couples the two second bent portions 313 to each other. Thus, in the present embodiment, the contact 30 has the contact portion 305, the at least one first bent portion 311 and the at least one second bent portion 313. Moreover, in the present embodiment, the contact 30 has the first coupling portion 315 which couples the two first bent portions 311 to each other and the second coupling portion 317 which couples the two second bent portions 313 to each other.

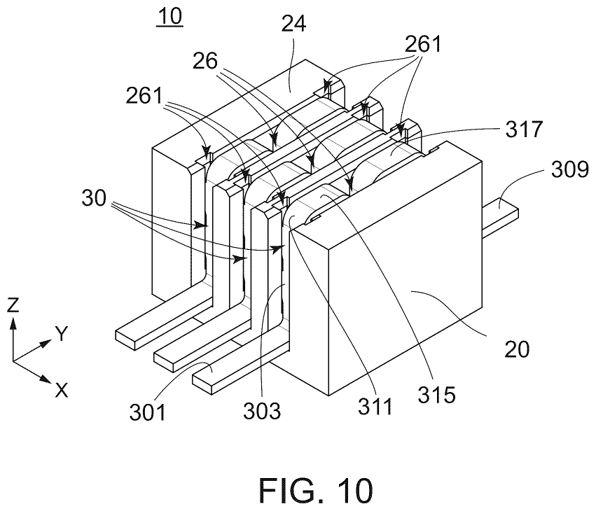

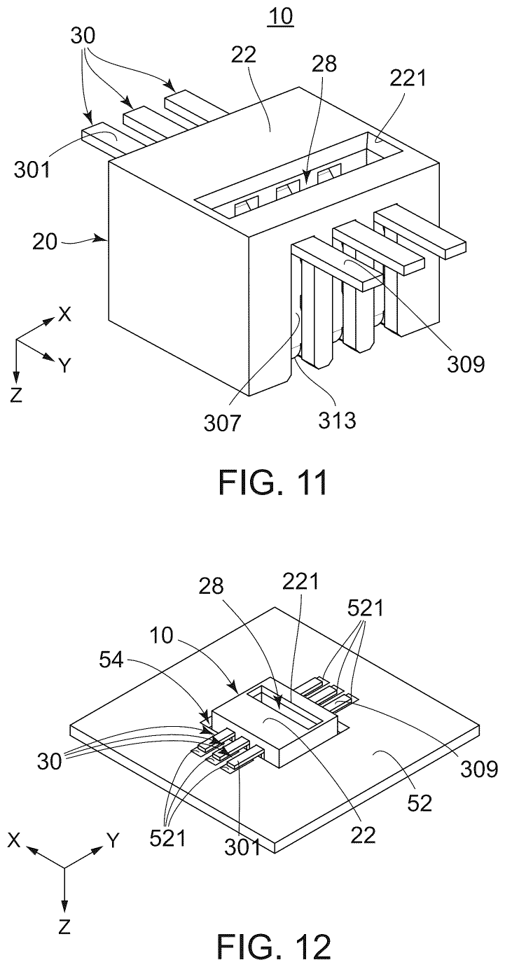

As understood from FIGS. 8 to 11, the contacts 30 are held by the housing 20. In detail, the first held portion 303 and the second held portion 307 of each of the contacts 30 are held by the housing 20. In the present embodiment, each of the contacts 30 is inserted into the receiving portion 26 corresponding thereto through a side of the opposite surface 24 of the housing 20, and the first held portion 303 and the second held portion 307 of the contact 30 are press-fitted into holding portions 261 of the receiving portion 26 of the housing 20, respectively. Thus, in the present embodiment, the first held portion 303 and the second held portion 307 are press-fit portions. However, the present invention is not limited thereto. In this invention, the contacts 30 may be held by the housing 20 by a method other than the press-fitting, such as by an integral molding.

As shown in FIG. 3, in the present embodiment, the first coupling portion 315 and the second coupling portion 317 are visible through the opposite surface 24 of the housing 20. This is because the housing 20 is formed so that it receives the contacts 30 in the receiving portions 26 through the side of the opposite surface 24. However, the present invention is not limited thereto. In this invention, the housing 20 may be formed so that is receives the contacts 30 through a side of the mating surface 22. In that case, the first coupling portion 315 and the second coupling portion 317 may or may not be visible through the opposite surface 24 of the housing 20. Nevertheless, in a case where the housing 20 is formed so that it receives the contacts 30 through the side of the opposite surface 24, there is an advantage that the housing 20 does not receive a force having a direction for making the contacts 30 fall away from the housing 20 when the module card 70 is not inserted into the aperture 221 but brought into abutment with the housing 20. Moreover, there is another advantage that each of the contacts 30 does not receive a force having a direction for falling away from the housing 20 when the module card 70 is extracted from the edge connector 10.

As shown in FIG. 7, the first mounted portion 301 and the second mounted portion 309 are located nearer to the mating surface 22 than to the opposite surface 24 and protrude outside from the housing 20. The first mounted portion 301 and the second mounted portion 309 are identical with each other in position in the up-down direction. In the present embodiment, the first mounted portion 301 protrudes forward from the housing 20, and the second mounted portion 309 protrudes rearward from the housing 20. In the present embodiment, the front-rear direction is a Y-direction. A negative Y-direction is directed forward while a positive Y-direction is directed rearward.

As understood from FIG. 1, the first mounted portion 301 and the second mounted portion 309 of the contact 30 are fixed to the substrate 50 when the edge connector 10 is mounted on the substrate 50. The substrate 50 has connection pads 521 formed on a first surface 521 thereof. In the present embodiment, the edge connector 10 is mounted on the first surface 52, which is directed upward, of the substrate 50, and the first mounted portions 301 and the second mounted portions 309 of the contacts 30 are connected to the connection pads 521.

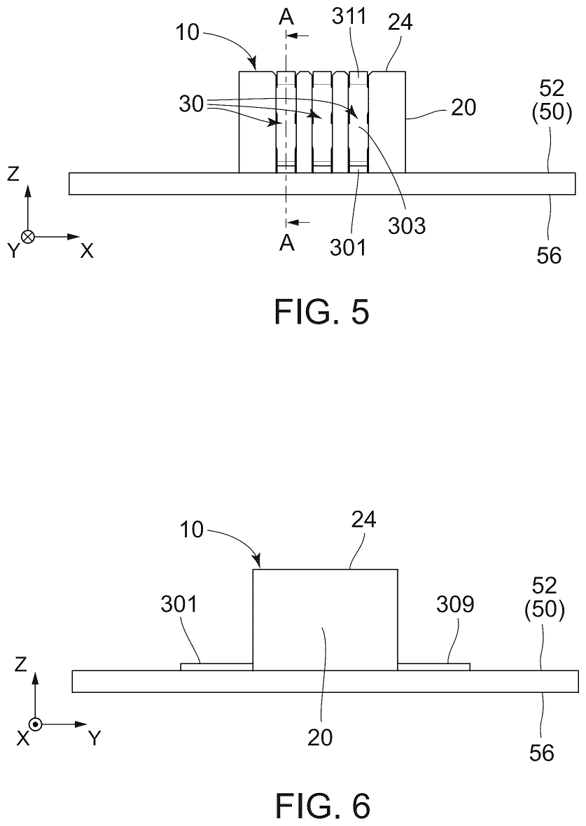

As shown in FIGS. 3, 4 and 7, in the present embodiment, the substrate 50 is formed with an opening portion 54. The housing 20 of the edge connector 10 mounted on the substrate 50 is inserted into the opening portion 54 in part. As shown in FIGS. 5 and 6, the housing 20 does not protrude from a second surface 56 of the substrate 50. With this structure, a combination of the edge connector 10 and the substrate 50 can be reduced in height.

As shown in FIG. 7, the first held portion 303 is located between the first mounted portion 301 and the contact portion 305 in the contact 30. Moreover, the second held portion 307 is located between the second mounted portion 309 and the contact portion 305 in the contact 30. The contact portion 305 is located between the first held portion 303 and the second held portion 307 in the contact 30 and positioned in the accommodation portion 28 of the housing 20. The supporting portion 32 has a part protruding rearward so that the contact portion 305 is positioned in the accommodation portion 28. In detail, the supporting portion 32 has a dog leg shape part which extends backward-diagonally upward and then extends forward-diagonally upward between one of the first bent portions 311 and one of the second bent portions 313. With this structure, the contact portion 305 is supported from two directions.

As understood from FIG. 7, the supporting portion 32 is resiliently deformable, and the contact portion 305 is movable at least in the front-rear direction. When the edge portion 72 of the module card 70 is inserted into the accommodation portion 28 of the housing 20, the supporting portion 32 is resiliently deformed and allows the edge portion 72 to enter the accommodation portion 28. Then, the contact portion 305 is pressed on a pad 721 formed on the edge portion 72 by a reaction force of the supporting portion 32. Here, the contact portion 305 is supported from the two directions as mentioned above. This structure gives a high resilient limit to the supporting portion 32. Accordingly, when the edge portion 72 of the module card 70 is inserted into and removed from the accommodation portion 28 of the housing 20, plastic deformation or buckling of the contacts 30 can be prevented or suppressed.

As shown in FIG. 7, the first bent portions 311 are located between the first held portion 303 and the contact portion 305 in the contact 30. The second bent portions 313 are located between the second held portion 307 and the contact portion 305 in the contact 30. The first bent portions 311 and the second bent portions 313 are provided to the contact 30 as just described, so that a length of the contact 30 from each of the first held portion 303 and the second held portion 307 to the contact portion 305 or a length of the supporting portion 32 can be increased without enlarging the size of the contact 30 in the up-down direction and that stiffness of the contact 30 can be reduced. In other words, with this structure, both reduction of the height of the edge connector 10 and improvement of spring property of the contact 30 can be realized.

In the present embodiment, the first bent portions 311 are two in number, and the second bent portions 313 are two in number. In addition, the two first bent portions 311 and the first coupling portion 315 are located nearer to the opposite surface 24 than to the mating surface 22, and the two second bent portions 313 and the second coupling portion 317 are located nearer to the opposite surface 24 than to the mating surface 22. With this structure, without increasing the size of the contact 30 in the up-down direction, the length from each of the first held portion 303 and the second held portion 307 to the contact portion 305 can be longer than that in case where each of the first held portion 303 and the second held portion 307 is one in number. As a result, without reducing a resilient limit of the contact 30, the stiffness of the contact 30 can be reduced. In other words, the spring property of the contact 30 can be improved.

Although the specific explanation about the present invention is made above with reference to concrete embodiments, the present invention is not limited thereto but susceptible of various modifications and alternative forms without departing from the spirit of the invention.

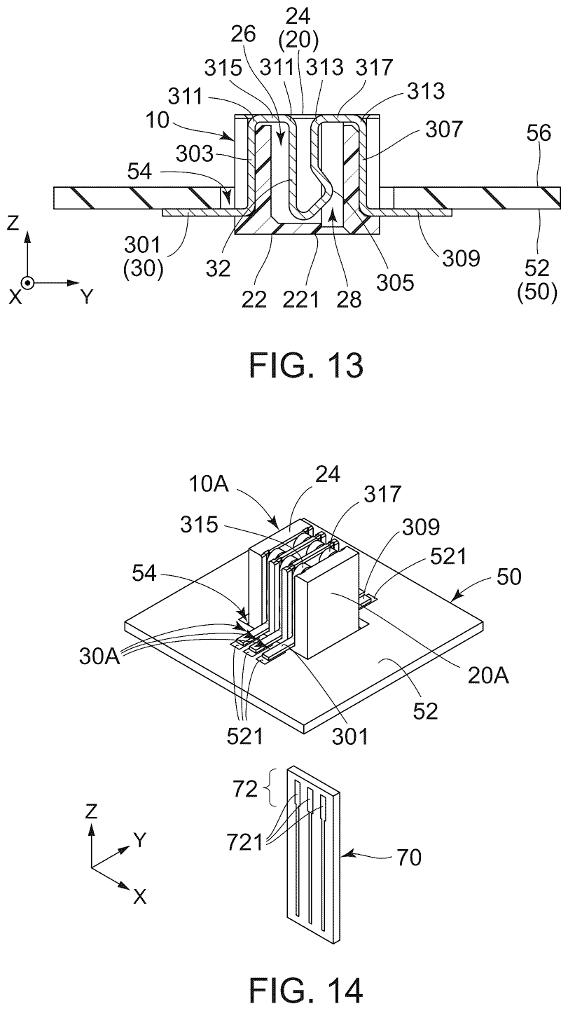

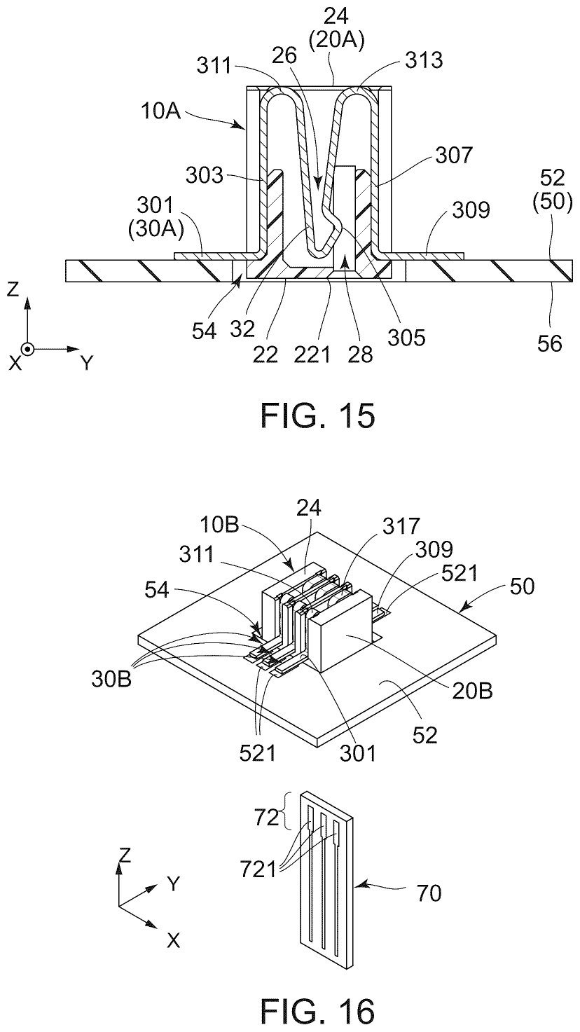

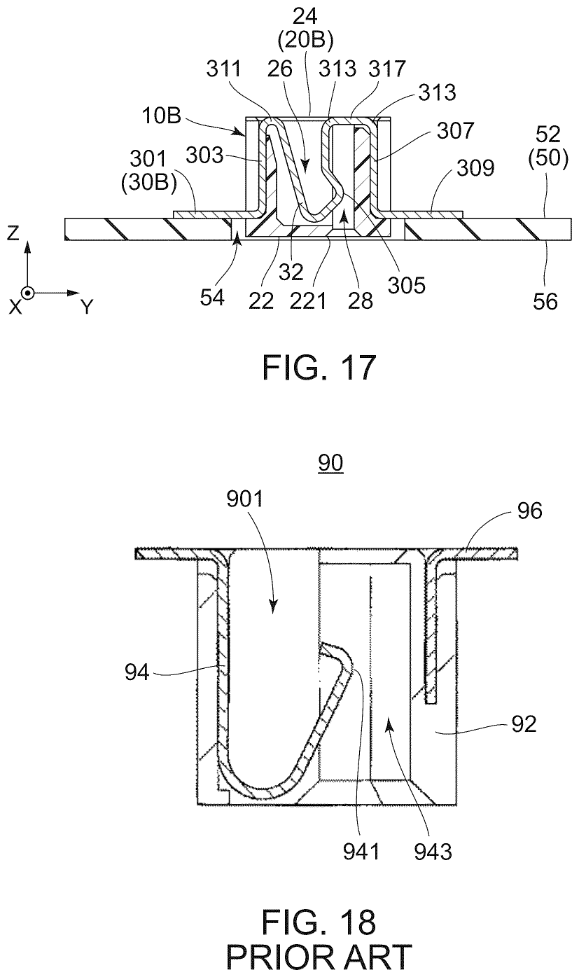

For example, although the edge connector 10 is mounted on the first surface 52 of the substrate 50 in a state that the first surface 52 of the substrate 50 is directed upward in the aforementioned embodiment, the edge connector 10 may be mounted on the first surface 52 of the substrate 50 in a state that the first surface 52 of the substrate 50 is directed downward as shown in FIGS. 12 and 13. In that case, the edge connector 10 protrudes from the second surface 56 of the substrate 50. However, a protrusion amount of the edge connector 10 from the first surface 52 of the substrate 50 can be reduced.

Although each of the number of the first bent portions 311 and the number of the second bent portions 313 is two in the aforementioned embodiment, each of the first bent portion 311 and the second bent portion 313 may be one in number. In that case, the contact 30 can be simple in shape and be easily manufactured.

Although the number of the first bent portions 311 and the number of the second bent portions 313 are equal to each other in the aforementioned embodiment, they may be different from each other. In that case, each of the number of the first bent portions 311 and the number of the second bent portions 313 should be at least one and may be three or more. Each of the number of the first bent portions 311 and the number of the second bent portions 313 may be decided on the basis of a spring property required in the contact 30.

In the present invention, the first bent portions 311 and the second bent portions 313 are not essential. The first bent portions 311 and the second bent portions 313 are for reducing the size of the edge connector 10 in the up-down direction. In order to improve the spring property of the contact 30, the length of the contact 30 from each of the first held portion 303 and the second held portion 307 to the contact portion 305 should be increased.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. An edge connector which is mounted on a mount object and into which an edge portion of a connection object is inserted, wherein:
the edge connector comprises a housing and a contact;
the housing has an accommodation portion which accommodates the edge portion;
the contact has a first mounted portion, a first held portion, a contact portion, a second held portion and a second mounted portion;
the first mounted portion and the second mounted portion are fixed to the mount object when the edge connector is mounted on the mount object;
the first held portion is located between the first mounted portion and the contact portion in the contact;
the second held portion is located between the second mounted portion and the contact portion in the contact;
the first held portion and the second held portion are held by the housing; and
the contact portion is located between the first held portion and the second held portion in the contact and located in the accommodation portion.

2. The edge connector as recited in claim 1, wherein:
the contact further has at least one first bent portion and at least one second bent portion;
the at least one first bent portion is located between the first held portion and the contact portion in the contact; and
the at least one second bent portion is located between the second held portion and the contact portion in the contact.

3. The edge connector as recited in claim 2, wherein:
the housing has a mating surface in which an aperture is formed and an opposite surface opposite to the mating surface;
the aperture communicates with the accommodation portion;
the edge portion is insertable into the accommodation portion through the aperture;
the first mounted portion and the second mounted portion are located nearer to the mating surface than to the opposite surface;
the at least one first bent portion comprises two first bent portions;
the contact has a first coupling portion which couples the two first bent portions to each other;
the two first bent portions and the first coupling portion are located nearer to the opposite surface than to the mating surface;
the at least one second bent portion comprises two second bent portions;
the contact has a second coupling portion which couples the two second bent portions to each other; and
the two second bent portions and the second coupling portion are located nearer to the opposite surface than to the mating surface.

4. The edge connector as recited in claim 3, wherein:
each of the first held portion and the second held portion comprises a press-fit portion;
the contact is inserted into the housing through a side of the opposite surface;
the first held portion and the second held portion are press-fitted into the housing; and
the first coupling portion and the second coupling portion are visible through the opposite surface of the housing.
